(19) United States
(12) Patent Application Publication
(10) Pub. No.: US 2016/0147114 A1
(43) Pub. Date: May 26, 2016

(54) ARRAY TEST MODULATOR AND DEVICE FOR INSPECTING THIN FILM TRANSISTOR SUBSTRATE INCLUDING THE SAME

(71) Applicant: SAMSUNG DISPLAY CO., LTD., Yongin-City (KR)

(72) Inventors: Kyung Seop KIM, Hwaseong-si (KR); Byeong-Beom KIM, Asan-si (KR); Chang Oh JEONG, Suwon-si (KR); Dong Min LEE, Anyang-si (KR)

(21) Appl. No.: 14/792,754

(22) Filed: Jul. 7, 2015

(30) Foreign Application Priority Data
Nov. 21, 2014 (KR) 10-2014-0163665

(51) Int. Cl. G02F 1/1335; G09G 3/00; G02F 1/13; G02B 27/14; G02F 1/29

(52) U.S. Cl. CPC G02F 1/133553; G02B 27/144; G02F 1/29; G02F 1/1309; G09G 3/006; G02F 2001/133302

(57) ABSTRACT

An array test modulator, including a first glass; a second glass facing the first glass and including a common electrode; a liquid crystal layer between the first glass and the second glass; and a reflection layer between the second glass and the liquid crystal layer and including a metal oxide layer.

### CROSS-REFERENCE TO RELATED APPLICATION

Korean Patent Application No. 10-2014-0163665, filed on Nov. 21, 2014, in the Korean Intellectual Property Office, and entitled: “Array Test Modulator and Device For Inspecting Thin Film Transistor Substrate Including The Same,” is incorporated by reference herein in its entirety.

### BACKGROUND

1. Field

Provided is an array test modulator and a device for inspecting a thin film transistor substrate including the same.

2. Description of the Related Art

A liquid crystal display, which is a flat panel display, may include two display panels on which electric field generating electrodes, such as a pixel electrode, and a common electrode are formed, and a liquid crystal layer formed therebetween. The liquid crystal display may display an image by generating an electric field on the liquid crystal layer by applying a voltage to the electric field generating electrodes, determining alignments of liquid crystal molecules of the liquid crystal layer through the generated electric field, and controlling polarization of incident light.

### SUMMARY

Embodiments may be realized by providing an array test modulator, including a first glass; a second glass facing the first glass and including a common electrode; a liquid crystal layer between the first glass and the second glass; and a reflection layer between the second glass and the liquid crystal layer and including a metal oxide layer.

The metal oxide layer may include a titanium oxide layer and an aluminum oxide layer.

The reflection layer may have a multi-layered structure including alternately stacked layers of TiO₂ and Al₂O₃.

The reflection layer may have nine layers.

The reflection layer may include a lowermost TiO₂ layer and an uppermost TiO₂ layer.

The TiO₂ layers may be 500 Å to 1000 Å thick.

The Al₂O₃ layers may be 900 Å to 1500 Å thick.

The reflection layer may have a multi-layered structure including alternately stacked layers of Al₂O₃ and one of ZrO, YO, or HfO.

The reflection layer may have a multi-layered structure including alternately stacked layers of TiO₂ and one of SiO or SiON.

The reflection layer may have an insulator property in an electrical manner.

The reflection layer may have entire light transmittance of 3% to 4%.

Resistivity of the reflection layer may be 1×10¹¹Ω/□ to 2×10¹¹Ω/□.

A fault of a pixel electrode of a thin film transistor may be inspected by detecting intensity of light that is output from a light source and is reflected from the array test modulator.

The light source may be a red light source with a wavelength of 570 nm to 680 nm.

Embodiments may be realized by providing a device for inspecting a thin film transistor substrate and determining whether a pixel electrode is faulty, the device including a light source; an array test modulator including a first glass, a second glass facing the first glass and including a common electrode, a liquid crystal layer between the first glass and the second glass, and a reflection layer between the second glass and the liquid crystal layer and including a metal oxide layer; a beam splitter changing a direction of beams generated by the light source and transmitting the beams generated by the light source to the array test modulator; an imagery lens collecting beams reflected from the array test modulator; and an image detector measuring intensity of beams collected by the imagery lens and determining whether a pixel electrode is faulty.

A fault of a pixel electrode of a thin film transistor may be inspected using output from the image detector.

### BRIEF DESCRIPTION OF THE DRAWINGS

Features will become apparent to those of skill in the art by describing in detail exemplary embodiments with reference to the attached drawings in which:

FIG. 1 illustrates a schematic diagram of a thin film transistor substrate inspecting device according to an exemplary embodiment;

FIG. 2A and FIG. 2B illustrate schematic diagrams of a method for determining whether a pixel electrode has a fault by an array test modulator according to an exemplary embodiment;

FIG. 3 illustrates a table of transmittance data according to a reflection layer structure;

FIG. 4 illustrates a graph comparing transmittance caused by a reflection layer structure of an array test modulator according to Examples and transmittance caused by a reflection layer structure of a test modulator according to a Comparative Examples;

FIG. 5 illustrates a graph for transmittance caused by thickness of a reflection layer of an array test modulator according to Examples with respect to a wavelength of a light source when the reflection layer included seven layers; and

FIG. 6 illustrates a graph of transmittance caused by thickness of a reflection layer of an array test modulator according to Comparative Examples with respect to a wavelength of a light source when the reflection layer included fifteen layers;

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

The drawings are schematic and are not illustrated in accordance with a scale. The relative sizes and ratios of the parts in the drawings may be exaggerated or reduced for clarity and convenience in the drawings, and an arbitrary size is only exemplary and is not limited. The same structures, elements, or parts illustrated in no less than two drawings are denoted by the same reference numerals in order to represent similar characteristics. When a part is referred to as being “on” another part, it can be directly on the other part or intervening parts may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present.

An exemplary embodiment is illustrated in detail. As a result, various modifications are expected to be made. Therefore, the exemplary embodiment is not limited to a specific shape of an illustrated region but, for example, includes a change in the shape in accordance with manufacturing.

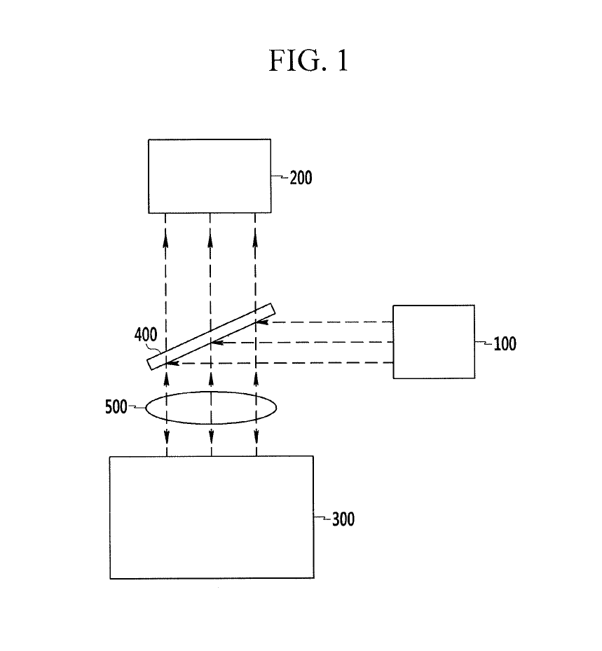

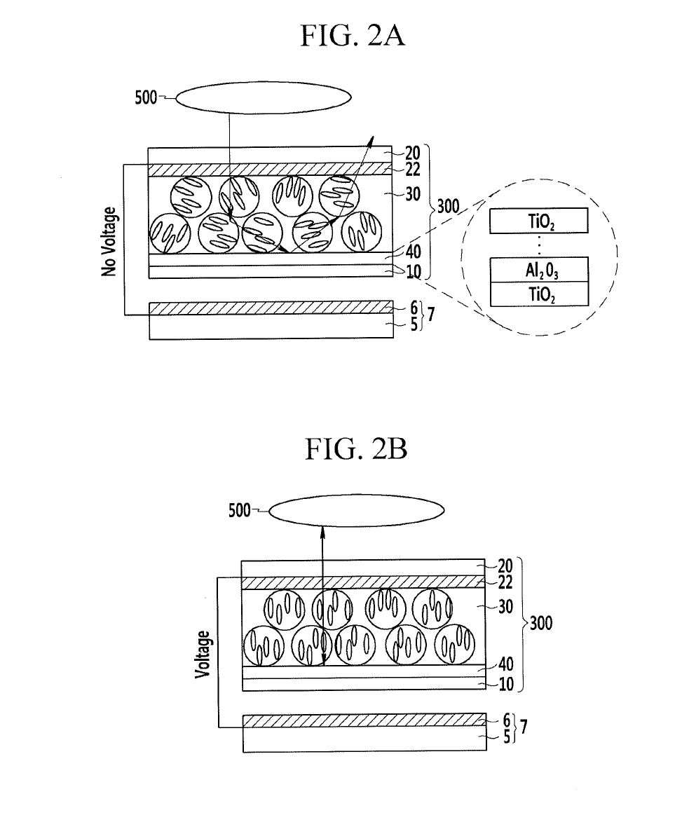

A thin film transistor substrate inspecting device according to an embodiment will now be described in detail with reference to FIG. 1, FIG. 2A, and FIG. 2B.

FIG. 1 illustrates a schematic diagram of a thin film transistor substrate inspecting device according to an exemplary embodiment, and FIG. 2A and FIG. 2B illustrate schematic diagrams of a method for determining whether a pixel electrode has a fault by an array test modulator according to an exemplary embodiment.

Referring to FIG. 1, the thin film transistor substrate inspecting device may include a light source 100, an array test modulator 300, a beam splitter 400, an imagery lens 500, and an image detector 200.

The light source 100 may generate predetermined beams and may output the beams to the beam splitter 400. The beam splitter 400 may change a route of the beams output by the light source 100 to transmit the beams to the array test modulator 300. The beams of which the route is changed by the beam splitter 400 may be focused at the imagery lens 500 and may be transmitted to the array test modulator 300. The array test modulator 300 may include a reflection layer, and the beams reflected from the reflection layer may be transmitted to the image detector 200 to detect intensity of the beams reflected from the array test modulator 300.

As shown in FIG. 2A and FIG. 2B, the array test modulator 300 may include a first glass 10 and a second glass 20 disposed to face the first glass 10 and including a common electrode 22, and a liquid crystal layer 30 may be formed between the first glass 10 and the second glass 20. The common electrode 22 may be attached to the second glass 20 facing the liquid crystal layer 30, and a reflection layer 40 including a metal oxide layer may be attached to the first glass 10 facing the liquid crystal layer 30. The common electrode 22 may be connected to a pixel electrode 6 of a thin film transistor substrate 5 of an inspected panel 7.

As shown in FIG. 2A, when the pixel electrode 6 is faulty, no electric field may be generated between the common electrode 22 and the pixel electrode 6, and liquid crystal molecules of the liquid crystal layer 30 between the common electrode 22 and the reflection layer 40 may be randomly disposed. The beams that are passed through the beam splitter 400 from the light source 100 and are gathered at the imagery lens 500 may be transmitted to the liquid crystal layer 30, and the beams reflected from the reflection layer 40 may be scattered by the randomly disposed liquid crystal molecules.

As shown in FIG. 2B, when the pixel electrode 6 is not faulty, an electric field may be generated between the common electrode 22 and the pixel electrode 6, and the liquid crystal molecules may be disposed in one same direction. The beams transmitted to the liquid crystal layer 30 may be reflected from the reflection layer 40 in an opposite direction of an incident direction and may be transmitted to the image detector 200.

Polarization and reflection characteristics of the beams passing through the liquid crystal layer 30 may depend on the state of whether the pixel electrode 6 is faulty or not, and the intensity of the beams reflected from the reflection layer 40 may be changed. The beams may be converted into output, e.g., electrical signals, by the image detector 200 to determine whether the pixel electrode 6 is faulty.

The light source 100 may be a red light source with a wavelength of 570 nm to 680 nm. A peak wavelength indicated by the maximum intensity of the light source 100 nm may be 636 nm.

The reflection layer 40 may have a property of an insulator in an electrical manner, and may be formed with a material having entire light transmittance of 3% to 4%. Resistivity of the reflection layer 40 may be greater than 1×10¹¹Ω/□ and less than 2×10¹¹Ω/□.

The reflection layer 40 may be a multi-layered structure in which a titanium oxide (TiO₂) layer and an aluminum oxide (Al₂O₃) layer are alternately stacked on the first glass 10, and the alternately disposed TiO₂ layer and Al₂O₃ layer may be stacked to form nine layers.

The TiO₂ layer may be provided on a lowermost layer and an uppermost layer of the reflection layer 40. In a stacked layer structure of TiO₂/Al₂O₃, the TiO₂ layer may be a high refractive index layer compared to the Al₂O₃ layer, and the TiO₂ layer may be provided on an edge of the first glass 10 and the uppermost layer of the reflection layer 40.

The first glass 10 may be formed to be about 500 μm thick. The TiO₂ layer may be formed to be about greater than 500 Å and less than 1000 Å, and the Al₂O₃ layer may be formed to be about greater than 900 Å and less than 1500 Å.

The reflection layer 40 may be replaced with one of ZrO, YO, or HfO instead of TiO₂. TiO₂ has a refractive index of greater than 2.0, and may be usable in substitution of ZrO, YO, and HfO having similar refractive indexes. For example, the reflection layer 40 may be a multi-layered structure in which one of ZrO, YO, or HfO and the Al₂O₃ are alternately stacked.

The reflection layer 40 may be replaced with one of SiO or SiON instead of Al₂O₃. Al₂O₃ has a refractive index that is less than 1.8, and may be substituted with SiO or SiON having a similar refractive index. For example, the reflection layer 40 may be a multi-layered structure in which TiO₂ and one of SiO or SiON are alternately stacked.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

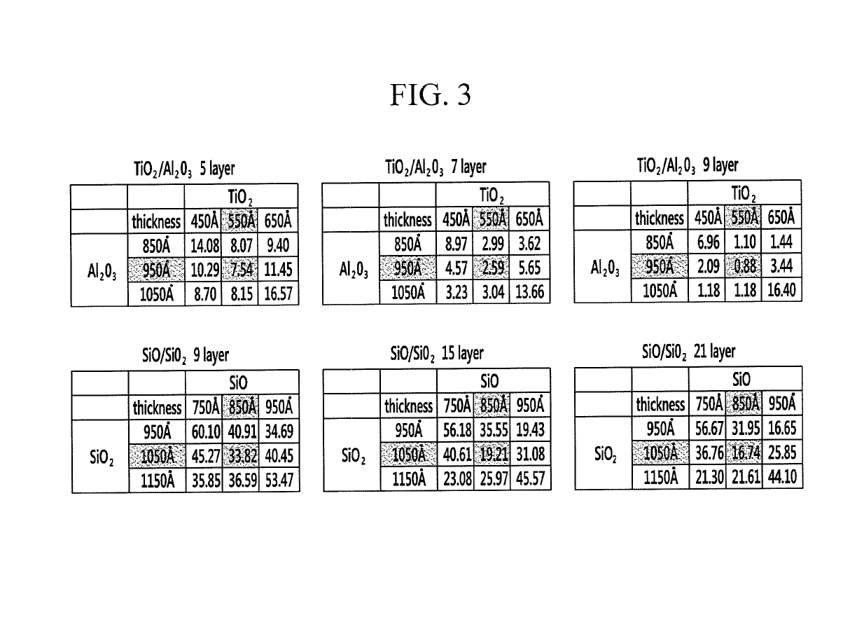

FIG. 3 illustrates a table of transmittance data according to a reflection layer structure. Referring to FIG. 3, materials of the reflection layer 40 and transmittance for thicknesses of the respective materials are provided, where the transmittance represents a ratio of beams that were input to the array test modulator 300 and were not reflected from the reflection layer 40 but were transmitted therethrough. Lower transmittance values correspond to a greater reflection characteristic of the reflection layer 40.

Referring to FIG. 3, when a reflection layer having a SiO/SiO₂ stacked structure was used in the wavelength of a light source of 570 nm to 680 nm, the thickness of SiO was 850 Å, and transmittance was low when the thickness of SiO₂ was 1050 Å. When SiO/SiO₂ included 9, 15, and 21 layers, the transmittance was 33.82%, 19.21%, and 16.74%, respectively. The SiO/SiO₂ stacked structure may include a single SiO layer and two layers in which one single SiO₂ layer is stacked. For example, the nine layer SiO/SiO₂ included five layers of SiO and four layers of SiO₂, and the lowermost layer and the uppermost layer were SiO. The TiO₂/Al₂O₃ stacked structure had a lowermost layer and an uppermost layer of TiO₂.

When the TiO₂/Al₂O₃ stacked structure was used for the structure of the reflection layer 40 in the wavelength of a light source of 570 nm to 680 nm, a thickness of TiO₂ was 550 Å, and when a thickness of Al₂O₃ was 950 Å, transmittance was low. When TiO₂/Al₂O₃ included 5, 7, and 9 layers, the transmittance was 7.54%, 2.59%, and 0.88%, respectively.

As shown in FIG. 3, when the reflection layer 40 included the TiO₂/Al₂O₃ stacked structure, a lower transmittance may obtained with a smaller thickness and a smaller number of stacked layers compared to the SiO/SiO₂ stacked structure. The TiO₂/Al₂O₃ stacked structure may have a relatively large refractive index between two layers compared to the SiO/SiO₂ stacked structure, interface reflection may be readily generated, and the TiO₂/Al₂O₃ stacked structure may have lower transmittance.

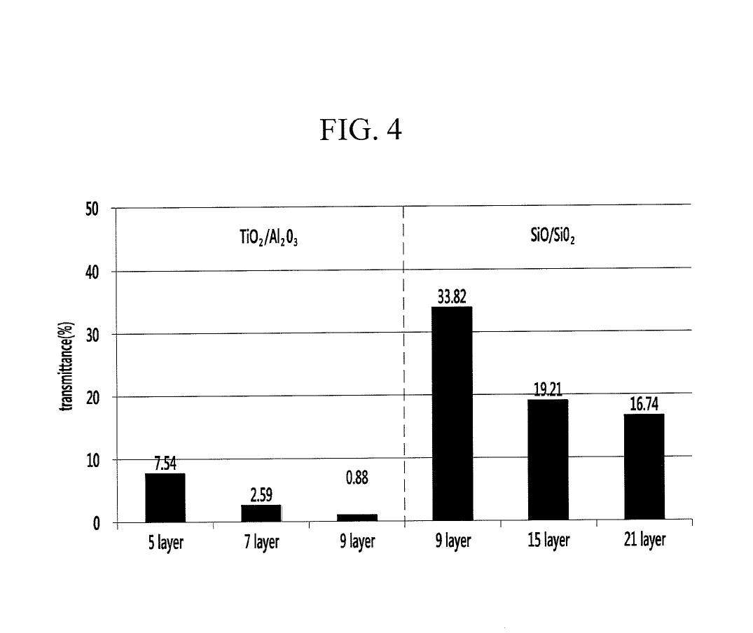

FIG. 4 illustrates a graph comparing transmittance caused by a reflection layer structure of an array test modulator according to Examples and transmittance caused by a reflection layer structure of a test modulator according to Comparative Examples.

As shown in FIG. 4, when the TiO₂/Al₂O₃ stacked structure was used, the transmittance was less than 10% when the structure included 5, 7, and 9 layers, lower transmittance than that of the 21-layered structure of SiO/SiO₂ may be realized by using the 5-layered structure, and a TiO₂/Al₂O₃ stacked structure may be used in the reflection layer 40, e.g., in a thickness of the reflection layer 40.

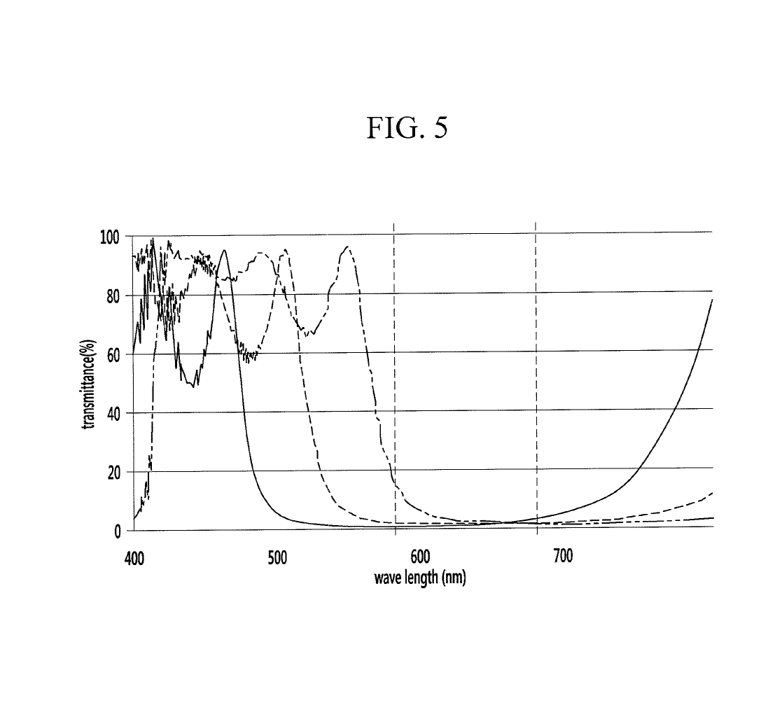

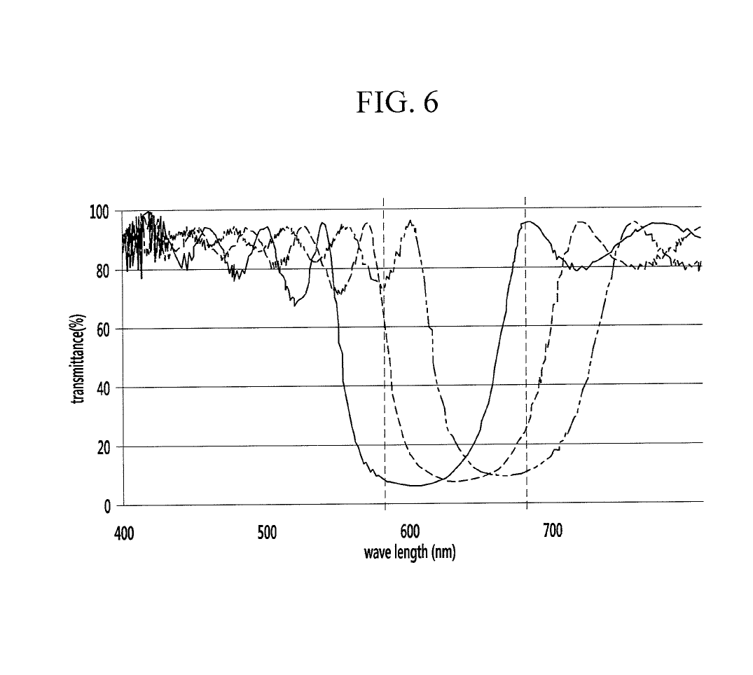

FIG. 5 illustrates a graph for transmittance caused by thickness of a reflection layer of an array test modulator according to Examples with respect to a wavelength of a light source when the reflection layer included seven layers, and FIG. 6 illustrates a graph of transmittance caused by thickness of a reflection layer of an array test modulator according to Comparative Examples with respect to a wavelength of a light source when the reflection layer included fifteen layers.

Referring to FIG. 5, when the reflection layer 40 included seven layers of TiO₂/Al₂O₃ and the wavelength of the light source was 570 nm to 680 nm, the transmittance of the reflection layer 40 was low. The TiO₂/Al₂O₃ stacked structure may have a relatively large refractive index, and a wavelength range for generating reflection constructive interference may be wide and big. The thickness of the Al₂O₃ layer was 1050 Å, and transmittance was measured while changing the thickness of the TiO₂ layer. The solid line represents a change of transmittance when the TiO₂ layer was 450 Å thick, the one-point chain line represents a change of transmittance when TiO₂ layer was 550 Å thick, and the two-point chain line represents a change of transmittance when the TiO₂ layer was 650 Å thick.

Referring to FIG. 6, when the reflection layer 40 included 15 layers of SiO/SiO₂ and the wavelength of the light source was 570 nm to 680 nm, the transmittance of the reflection layer 40 was low. The SiO/SiO₂ stacked structure may have a relatively small refractive index difference, and the wavelength range for generating reflection constructive interference was narrow and small. The thickness of the SiO₂ layer was 1050 Å, and the transmittance was measured while changing the thickness of the SiO layer. The solid line represents a change of transmittance when the SiO layer was 750 Å thick, the one-point chain line represents a change of transmittance when the SiO layer was 850 Å thick, and the two-point chain line represents a change of transmittance when the SiO layer was 950 Å thick.

Referring to FIG. 1, the thin film transistor substrate inspecting device according to an exemplary embodiment may include an array test modulator, a light source, a beam splitter, an imagery lens, and an image detector according to the above-described exemplary embodiment.

For example, the thin film transistor substrate inspecting device according to the exemplary embodiment may include a light source, a first glass, a second glass disposed to face the first glass and including a common electrode, a liquid crystal layer formed between the first glass and the second glass, and a reflection layer provided between the second glass and the liquid crystal layer and including a metal oxide layer, and may include an array test modulator for detecting intensity of the light output by the light source and reflected and inspecting whether a pixel electrode of the thin film transistor has a fault, a beam splitter for changing a direction of beams generated by the light source and providing them to the array test modulator, an imagery lens for collecting the beams reflected from the array test modulator, and an image detector for measuring intensity of the beams collected by the imagery lens and determining whether the pixel electrode has a fault.

By way of summation and review, electrodes and thin film transistors (TFT) configuring pixels may require accurate driving to accurately display an image. A TFT substrate inspecting device may be used to test whether a pixel electrode of a TFT substrate has a fault before a display panel is compressed.

A TFT substrate inspecting device may include a light source for generating predetermined beams and outputting them, and a modulator for checking whether the pixel electrode of the TFT substrate has a short circuit fault. When a voltage at the pixel electrode is changed, polarization and reflection characteristics of the light passing through liquid crystal and intensity of the light may be changed. The light may be transformed into output, e.g., an electrical signal, by an image detector to determine whether the pixel electrode has a fault or not.

A reflection layer of a modulator may be formed by alternately stacking silicon oxides (SiO and SiO₂). The silicon oxides may have low hardness and may be easily scratched, refractive index differences between the silicon oxides may be small and the silicon oxides may have high transmittance, and when the reflection layer is formed to be relatively thick, their thin films may be peeled off, for example, due to stress.

Provided is an array test modulator including a reflection layer for checking a short circuit of a pixel electrode, and a device for inspecting a thin film transistor substrate including the same. More specifically, an array test modulator is provided that may realize low transmittance and high reflectance by forming a reflection layer of an array test modulator of a thin film transistor (TFT) substrate inspecting device in a multi-layered structure in which a titanium oxide (TiO₂) layer and an aluminum oxide (Al₂O₃) layer are alternately stacked.

According to the array test modulator according to an exemplary embodiment and the thin film transistor substrate inspecting device including the same, low light transmittance may be realized with a relatively smaller thickness of the reflection layer of the array test modulator.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An array test modulator, comprising:
a first glass;
a second glass facing the first glass and including a common electrode;
a liquid crystal layer between the first glass and the second glass; and
a reflection layer between the second glass and the liquid crystal layer and including a metal oxide layer.

2. The array test modulator as claimed in claim 1, wherein the metal oxide layer includes a titanium oxide layer and an aluminum oxide layer.

3. The array test modulator as claimed in claim 2, wherein the reflection layer has a multi-layered structure including alternately stacked layers of TiO₂ and Al₂O₃.

4. The array test modulator as claimed in claim 3, wherein the reflection layer has nine layers.

5. The array test modulator as claimed in claim 3, wherein the reflection layer includes a lowermost TiO₂ layer and an uppermost TiO₂ layer.

6. The array test modulator as claimed in claim 3, wherein the TiO₂ layers are 500 Å to 1000 Å thick.

7. The array test modulator as claimed in claim 3, wherein the Al₂O₃ layers are 900 Å to 1500 Å thick.

8. The array test modulator as claimed in claim 1, wherein the reflection layer has a multi-layered structure including alternately stacked layers of Al₂O₃ and one of ZrO, YO, or HfO.

9. The array test modulator as claimed in claim 1, wherein the reflection layer has a multi-layered structure including alternately stacked layers of TiO₂ and one of SiO or SiON.

10. The array test modulator as claimed in claim 1, wherein the reflection layer has an insulator property in an electrical manner.

11. The array test modulator as claimed in claim 1, wherein the reflection layer has entire light transmittance of 3% to 4%.

12. The array test modulator as claimed in claim 1, wherein resistivity of the reflection layer is 1×10¹¹Ω/□ to 2×10¹¹Ω/□.

13. The array test modulator as claimed in claim 1, wherein a fault of a pixel electrode of a thin film transistor is inspected by detecting intensity of light that is output from a light source and is reflected from the array test modulator.

14. The array test modulator as claimed in claim 13, wherein the light source is a red light source with a wavelength of 570 nm to 680 nm.

15. A device for inspecting a thin film transistor substrate and determining whether a pixel electrode is faulty, the device comprising:
a light source;
an array test modulator including a first glass, a second glass facing the first glass and including a common electrode, a liquid crystal layer between the first glass and the second glass, and a reflection layer between the second glass and the liquid crystal layer and including a metal oxide layer;
a beam splitter changing a direction of beams generated by the light source and transmitting the beams generated by the light source to the array test modulator;
an imagery lens collecting beams reflected from the array test modulator; and
an image detector measuring intensity of beams collected by the imagery lens.

16. The device as claimed in claim 15, wherein a fault of a pixel electrode of a thin film transistor is inspected using output from the image detector.
